(19) United States
(12) Patent Application Publication
(10) Pub. No.: US 2023/0385885 A1
(43) Pub. Date: Nov. 30, 2023

(54) Automated triggering of transactions, system and method

(71) Applicant: CupLoop OÜ, Tallinn (EE)

(72) Inventors: Christopher Juul, Tallinn (EE); Lauri Luik, Haapsalu (EE); Marek Suchazevski, Tallinn (EE)

(21) Appl. No.: 18/031,843

(22) PCT Filed: Oct. 12, 2021
(86) PCT No.: PCT/EP2021/078231

§ 371 Date: Apr. 13, 2023

(30) Foreign Application Priority Data
Oct. 15, 2020 (EP) 20202045.9

(51) Int. Cl. G06Q 30/06; G07G 1/00; G06Q 20/10; G06Q 20/20; G06Q 20/32

(52) U.S. Cl. CPC G06Q 30/06; G07G 1/0045; G06Q 20/10; G06Q 20/204; G06Q 20/3278

(57) ABSTRACT

A system for automatically triggering a transaction includes at least one receiving component configured to receive at least one item to be returned, at least one processing component configured to process the at least one item to be returned and process data related to the at least one item to be returned, and at least one transaction processing component configured to perform at least one transaction related to the item to be returned. A method for automatically triggering a transaction includes generating data related to at least one item to be returned, processing the data related to the at least one item to be returned, generating at least one transaction data related to the item to be returned, and processing the at least one at least one transaction data related to the item to be returned.

### FIELD

The invention lies in the field of re-collection and/or recycling and/or refunding processes and particularly in the field of automated triggering of transactions related to re-collection and/or recycling and/or refunding processes.

### BACKGROUND

Industry trends show that the credit and debit cards are becoming the preference of more and more consumers in the marketplace. Consumers are making more payments using electronic payment methods than with cash or check-based payment methods. Across the Euro area, in 2016, around 79 percent of all payments at POS were made with cash, 19 percent with cards and 2 percent with other payment instruments. In terms of value, the market share of main payment instruments was: card payments accounted for 46% of all transactions, while credit transfers and direct debits accounted each for 23%.

The payment instrument industry is constantly exploring new solutions to attract new customers and to make the act of purchasing easier. Contactless card payments, as well as mobile-based card transactions, are the best-known examples. For some years now, cards market players have been seeking solutions to ensure their technological independence, which is essential for them to survive.

In the card-to-terminal domain, the European Card Payment Cooperation (ECPC) has been established to develop a generic card and mobile payment application specification, the CPA contactless extension (CPACE), which can be used in different environments (contact and contactless cards, mobile near field communication (NFC), remote transactions). CPACE adds card and mobile extensions for both contactless and remote payments to the EMVCo CPA standard specification and enables national schemes to develop interoperable extensions for contactless transactions with EMV-based cards. It also allows European card issuers and schemes to become independent from proprietary contactless applications currently available. This European contactless payment application goes together with the provision of a European kernel (core software for POS terminals) for payment acceptance.

At the same time, other private stakeholders' specifications (e.g. PURE) and related products and services offer white label solutions to national schemes or local labels. The suite includes a scheme-agnostic EMV payment application adopted by many actors for various white label payment offers involving contact/contactless mobile/cards devices and wearables. The core specifications address both issuance (cloud-based and secure element) and acceptance (POS kernel) fields.

The number of cards with a payment function in the EU increased in 2017 by 2.0% to 812 million. With a total EU population of 513 million, this represented around 1.6 payment cards per EU inhabitant. The number of card transactions rose by 11.2% to 69.2 billion, with a total value of €3.1 trillion. This corresponds to an average value of around €44 per card transaction. The volume of small payments in the physical POS (e.g. retail card reader, cash register, bar code scanner, product vending machines, parking meters, etc.), digital (e.g. online, etc.), and mobile (e.g. cell phone, etc.) markets is escalating at a staggering pace.

With the increase in the number of card users an automated payment method is required. Various payment systems are in place to automate the process. For example, U.S. Pat. No. 6,529,880B1 an automated payment system for a plurality of remote merchants includes a clearinghouse server, a plurality of customer tags and a plurality of local merchant systems. The clearinghouse system includes a customer database and merchant database. A customer joining the clearinghouse service is provided with a customer tag, such as an RFID transponder, which stores a tag identification number. Each remote merchant includes a local merchant system which includes a reader, point-of-sale system, a customer database and a transaction database. The reader is adapted to automatically retrieve the tag identification number from a customer tag when the customer tag is within an associated reading area, such as a stopping location of drive-through lane or a short-term parking stall. The customer's order is entered and processed on the point-of-sale system which is adapted to handle both standard cash transactions and authorized cashless transactions. The authorization database includes tag identification numbers for each tag of a customer authorized to use the automated payment system. A search is conducted in the authorization database for the tag identification number retrieved by the reader, and if found, the point-of-sale system is authorized to process a cashless transaction for the associated customer. The transaction database stores information for each authorized cashless transaction completed by the point-of-sale system, and periodically transmits the stored transaction information to the clearinghouse system which withdraws funds from the associated customer account and remits payment to the associated merchant account.

As also disclosed in the example the wireless such as NFC are becoming increasingly prevalent in order to facilitate the automated payment. Usually, the NFC reader is positioned at point of sale (PoS) and is used to buy commodity or service at retail location. When a consumer purchases a commodity and/or service it is easy to pay at the PoS using several payment options. But when it comes to return a product, commodity and/or service it is usually refunded on the same mode of payment as was used during the purchase.

Currently, there are no systems developed so far which can refund the payment to the customer in a payment mode different than what was used to make the purchase. This does not include the reward points as in most cases the reward points can only be used with the same merchant as the purchase was made from.

Furthermore, s when the amount to be returned is less than a certain threshold value, it might not be worth for the issuers to return the amount and incur the transaction fees. For example, as the token money for shopping carts/trolleys in supermarkets and airports. The security money charged usually is less than, for instance, 2€, to refund/reimburse this amount using a third-party issuer may not be economically worth.

### SUMMARY

In light of the above, it is an object of the present invention to overcome the shortcomings of already existing systems and methods. More particularly, it is an object of the present invention to provide a system, a method and a computer-implemented program product to make the refunds/reimburse efficient. It is also a goal of the present invention to provide an efficient and reliable way of automatically triggering a transaction. More particularly, the present invention relates to a system for an automated triggering of a refund transaction related to a re-collection and/or recycling and/or refunding process, a method performed in such a system and corresponding use of such a system.

In a first aspect, the invention relates to a an system for automatically triggering a transaction, the system comprising at least one receiving component configured to receive at least one item to be returned, at least one processing component configured to process the at least one item to be returned and process data related to the at least one item to be returned, and at least one transaction processing component configured to perform at least one transaction related to the item to be returned.

The receiving component can comprise an input section that is configured to allow a user access to a receptacle to deposit the item. The input section can be any kind of movable and/or openable and/or closable component such as a lid. The way for the lid to open can have different ways or kinds. It can swivel or turn around a hinge and allow a user to access the inside of the receiving component to deposit an item. Other mechanisms or kinds to provide the same are also possible, such as a lens-blade kind of arrangement of blades, door-like arrangement and/or any combinations thereof. The input section can be configured to open the receptacle to allow a user to access the receptacle and after a deposit of an item to close the receptacle. It can be automatic, semi-automatic or can be configured to be manually opened by a user.

The input section can be configured to increase a bottom size of the receiving component for depositing an item when the input section is opened. This can be realized by a tilting or swiveling arrangement or any other arrangement that allows the input section to enlarge the bottom or bottom plate of the receiving component when it is open. This can be done by an arrangement and shape that allows to make the inner surface flush with the bottom of the receiving component in the open condition. A hinged configuration with the turning or swiveling points at a lower side can be arranged.

The input section can be further configured to assist the item to move into the receiving component when the input section is closing. This can be realized by the arrangement as described above.

The receiving component can further comprise at least one bottom lid that is configured to open and deposit an item by gravity. That is, when the bottom lid is opened one or more items will fall through the opening created into a bin or container below. The bottom lid can be hinged to a side of a bottom part of the receiving component. The receiving component can comprise two bottom lids that are configured to open and deposit an item by gravity. The two bottom lids can be hinged at opposing sides of a bottom part of the receiving component.

The receiving component can further comprise a display for a user that can show a graphic user interface (GUI) when in use.

The receiving component can be controlled to provide access to a user at a first time and then block access to a user at a second time and/or open a bottom of the receiving component at a third time.

In one embodiment, the at least one processing component further may comprise at least one point-of-sale (PoS) terminal, the at least one transaction processing component may comprise at least one payment terminal and the at least one item to be returned may comprise at least one item tag.

Moreover, the at least one item tag may comprise at least one of: NFC tag, Smart tag, RFID passive tag, QR code, Bar code, Text tags, Smart URL tags, and URI tags.

Additionally or alternatively, the system further may comprise at least one base unit. In one embodiment, the at least one base unit may comprise at least one tag generating component configured to generate at least type of item tag.

The tag generating component may further be configured to encode the at least one item tag with at least one item data.

Furthermore, the at least one item data may comprise a monetary value of the at least one item to be returned, preferably a float and/or integer data type.

The at least one item data may comprise a depreciation value of the at least one item to be returned, preferably a float and/or integer data type.

The at least one item data may comprise at least one condition of return, preferably a string data type.

The at least one item data may comprise at least one item identification data, preferably a float, integer, a pattern, or string datatype or a combination thereof.

The at least one base unit may further be configured to autonomously and/or semi-autonomously install the at least one item tag to the respective at least one item.

In another embodiment, the system may comprise at least one server, wherein the at least one server may comprise at least one of a local, and a remote server.

The at least one base unit may be configured to transmit the item data to the at least one server.

The system may further be configured to store the item data on at least one server storage component.

The system may comprise the at least one server storage component.

The at least one base unit may comprise at least one base unit storage component configured to exchange data with the at least one server.

The at least one tag generating component may comprise at least one computing unit configured to execute machine learning techniques, preferably supervised and/or semi supervised learning.

The at least one tag generating component may be configured to predict item data based on a historic data.

In one embodiment, system may be configured to automatically retrieve the historic data from an existing knowledgebase.

The at least one PoS terminal may be configured to automatically read the item tag.

The at least one PoS terminal may comprise at least one reader configured to read the item tag.

The at least one reader may comprise at least one of: RFID reader, NFC reader, optical scanner, pen type reader, and laser scanners.

Each processing component may comprise at least one computing unit, wherein each of the at least one computing unit may comprise at least one storage component.

Each processing component may be configured to access to the eat least one computing unit comprising at least one processing component.

In another embodiment, at least one of the at least one computing unit and at least one of the at least one storage component may be integrated into a single device.

At least one of the at least one PoS terminal may comprise at least one processing component, wherein at least one of the least one PoS terminal may be configured to access at least one of the at least one processing component.

At least one of the at least one processing component and at least one of the at least one PoS terminal may be integrated into a single device.

The at least one reader may be configured to transmit the item data to the at least one processing component.

The at least one reader and the at least one processing component may be integrated in the same device and configured to bidirectionally exchange data.

The at least one reader may be configured to transmit item data to the at least one processing component.

The at least one reader may be configured to use at least one communication protocol comprising at least one of: Bluetooth, WLAN, Zig-bee, RFID, NFC, Z-wave.

The one processing component may be configured to automatically generate at least one reimburse-value.

The at least one processing component may be configured to automatically generate at least one reimburse-value based on the item data.

The processing component may further be configured to retrieve at least portion of item data from the at least one server.

The system further may comprise at least one issuing component.

The at least one processing component may further be configured to transmit the at least one reimburse-value to the at least one issuing component.

The at least one processing component may be configured to store the at least one reimburse-value on the at least one server storage component.

The at least one issuing component may be configured to enable at least one bank transaction.

The at least one issuing component further may comprise an encrypted communication protocol.

The system may be configured to enable the issuing component access to at least portion of the item data stored on the server storage component.

The at least one issuing component may be configured to retrieve the at least one reimburse-value from the at least one server storage component.

The system may further be configured to transmit the at least one reimburse-value to the at least one payment terminal.

The at least one reimburse-value may be transmitted to the at least one payment terminal by means of the at least one processing component reimburse-value.

The at least one issuing component may be configured to transmit the at least one reimburse-value to the at least one payment terminal.

The at least one issuing component may be configured to enable a data exchange with the at least one payment terminal, preferably via the encrypted communication protocol.

The at least one payment terminal may comprise at least one operating system.

The at least one payment terminal may comprise at least one user interface.

The at least one payment terminal may comprise at least one user terminal.

The at least one user terminal may be configured to read at least one of: Credit card, debit card, EMV card, NFC card, RFID card, E-wallets, QR code, Barcode, Google pay, and Apply pay.

The system may further be configured to run a payment terminal application on a PC or mobile device.

The system may be configured to transmit the at least one reimburse-value to the at least one user terminal.

The at least one payment terminal may comprise a money outlet.

The money outlet may be configured to dispense cash/coins at least equal to the amount of the at least one reimburse-value.

The at least one payment terminal may further be configured to extract one user ID from the at least one user terminal.

The at least one payment terminal may be configured to transmit the user ID to the at least one issuing component.

The at least one payment terminal may be configured to transmit the user ID associated with the at least one reimburse-value to the at least one issuing component.

In a second aspect, the invention relates to a method for automatically triggering a transaction, the method comprising: generating data related to at least one item to be returned, processing the data related to the at least one item to be returned, generating at least one transaction data related to the item to be returned, and processing the at least one at least one transaction data related to the item to be returned.

The step of processing the data related to at least one item to be returned may comprise extracting an item data of the at least one item to be returned.

The at least one item to be returned may comprise at least one item tag.

The at least one item tag may comprise at least one of: NFC tag, Smart tag, RFID passive tag, QR code, Bar code, Text tags, Smart URL tags, and URI tags.

In another embodiment, the method may comprise generating at least one type of item tag by means of at least one tag generating component comprise by at least one base unit.

Additionally or alternatively, the method may comprise encoding the at least one item tag with at least one item data using the at least one tag generating component.

The at least one item data may comprise a monetary value of the at least one item to be returned, preferably a float and/or integer data type.

The at least one item data may comprise a depreciation value of the at least one item to be returned, preferably a float and/or integer data type.

The at least one item data may comprise at least one condition of return, preferably a string data type.

The at least one item data may comprise at least one item identification data, preferably a float, integer, a pattern, or string datatype or a combination thereof.

The method may comprise autonomously and/or semi-autonomously installing the at least one item tag to the respective at least one item.

The method may comprise installing the at least one item tag to the respective at least one time using the at least one base unit.

The method may comprise transmitting the item data to at least one server.

The at least one server may comprise at least one of a local, and a remote server.

The method may comprise storing the item data on at least one server storage component.

The method may comprise exchanging data with the least one server.

The method may comprise exchanging data between the least one server and the at least one base unit.

The at least one base unit may comprise at least one base unit storage component and wherein the method may comprise exchanging data between the at least one server and the at least one base unit storage component.

The method may comprise executing machine learning techniques, preferably supervised and/or semi supervised learning.

The method may comprise executing machine learning techniques via at least one computing unit.

The at least one computing unit may be comprised by the at least one tag generating component.

The method may comprise predicting item data based on historic data.

The method may comprise automatically retrieving the historic data from an existing knowledgebase.

The method may comprise automatically reading the item tag by means of at least one PoS terminal.

The at least one PoS terminal may comprise at least one reader configured to read the item tag.

The at least one reader may comprise at least one of: RFID reader, NFC reader, optical scanner, pen type reader, and laser scanners.

The method may comprise accessing at least one computing unit comprising at least one processing component.

In one embodiment, at least one of the at least one PoS terminal may comprise at least one processing component, wherein the method may comprise at least one of the at least one processing component.

The method may comprise transmitting the item data from at least one reader to the at least one processing component.

The at least one reader may be configured to use at least one communication protocol comprising at least one of: Bluetooth, WLAN, Zig-bee, RFID, NFC, and Z-wave.

The method may comprise automatically generating at least one reimburse-value via the at least one processing component.

The at least one reimburse-value may be based on the item data.

The method may comprise retrieving at least one portion of item data from the at least one server via the at least one processing component.

The method may comprise transmitting the at least one reimburse-value to at least one issuing component via the at least one processing component.

The method may comprise storing the at least one reimburse-value on the at least one server storage component via the at least one processing component.

The method may comprise enabling at least one bank transaction via the at least one issuing component.

The method comprising encrypting data by means of an encrypted communication protocol comprise by the at least one issuing component.

The method comprising enabling the issuing component access to at least portion of the item data stored on the server storage component.

The method may comprise retrieving the at least one reimburse-value from the at least one server storage component via the at least one issuing component.

The method may comprise transmitting the at least one reimburse-value to the at least one payment terminal.

The at least one reimburse-value may be transmitted to the at least one payment terminal by means of the at least one processing component.

The method may comprise transmitting the at least one reimburse-value to the at least one payment terminal via the at least one issuing component.

The method may comprise enabling a data exchange with the at least one payment terminal, preferably via the encrypted communication protocol, via the at least one issuing component.

The at least one payment terminal may comprise at least one operating system.

The at least one payment terminal may comprise at least one user interface.

The at least one payment terminal may comprise at least one user terminal.

The method may comprise reading via at least one user terminal at least one of: Credit, debit card, EMV card, NFC card, RFID card, E-wallets, QR code, Barcode, Google pay, and Apply pay.

The method may comprise running a payment terminal application on a PC or mobile device.

The method transmitting the at least one reimburse-value to the at least one user terminal.

The at least one payment terminal may comprise a money outlet.

The money outlet may be configured to dispense cash/coins at least equal to the amount of the at least one reimburse-value.

The at least one payment terminal may further be configured to extract one user ID from the at least one user terminal.

The at least one payment terminal may be configured to transmit the user ID to the at least one issuing component.

The at least one payment terminal may be configured to transmit the user ID associated with the at least one reimburse-value to the at least one issuing component.

The method may comprise retrieving information related to a user and executing at least one online currency transferring, wherein the method may comprise using the information related to the user to transfer an amount of currency from a bank account to a user bank account, wherein in some embodiments the bank account may be different from the user bank account.

The method further may comprise prompting the user to introduce an NFC bank car into a bank terminal, and initiating a transaction.

The transaction may comprise at least one of a reversal payment, and a regular payment.

The method further may comprise retrieving bank card data such as card number, card issuer bank, validation date.

The method further may comprise processing the bank card data, wherein processing the bank card data may comprise matching the bank card data collected with the user's name and IBAN.

The method may comprise generating matches between the bank card data collected with the user's name and IBAN, wherein in case of no matches, the method may comprise generating a request, and sending the request to the card issuer bank.

The method may comprise receiving from the card issuer bank data based upon the request, wherein the card issuer data may comprise further information for connecting the user's bank card and IBAN.

The method may comprise saving the user's data and proceeding to perform any of the steps according to any of the preceding method embodiments.

The method may comprise controlling the system as recited herein to execute the method as recited herein.

Moreover, the invention also relates to the use of the system as recited herein for carrying out the method as recited herein.

Furthermore, the invention relates to a computer program product comprising instructions, which, when the program is executed by a user terminal device, causes a user terminal device to perform the method steps as recited herein, which have to be executed on the user terminal device, wherein the user device may be according to the system as recited herein that may comprise a user terminal device that may be compatible to said method.

In another embodiment, the computer program product may comprise instructions, which, when the program may be executed by a combination of a server and user terminal device, cause the server and the user terminal device to perform the method as recited herein, which have to be executed on the server and the user terminal device, wherein the user device and the server may be according to the system as recited herein that may comprise a sever and/or the user device that may be compatible to said method.

Additionally or alternatively, the computer program product may comprise instructions, which, when the program may be executed by a server, cause the server to perform the method as recited herein, which have to be executed on the server, wherein the server may be according to the system as recited herein that may comprise a server that may be compatible to said method.

Moreover, the computer program product may comprise instructions, which, when the program may be executed by a processing component, cause the processing component to perform the method as recited herein, which have to be executed on the processing component, wherein the processing component may be according to the system as recited herein that may comprise a processing component that may be compatible to said method.

The invention is further described with the following numbered embodiments.

Below, system embodiments will be discussed. These embodiments are abbreviated by the letter “S” followed by a number. Whenever reference is herein made to “system embodiments”, these embodiments are meant.

S1. A system for automatically triggering a transaction, the system comprising:
a. at least one receiving component (200) configured to receive at least one item to be returned;
b. at least one processing component (300) configured to
   i. process the at least one item to be returned, and
   ii. process data related to the at least one item to be returned; and
c. at least one transaction processing component (400) configured to perform at least one transaction related to the item to be returned.

S2. The system according to the preceding embodiment wherein the receiving component (200) comprises an input section (210) that is configured to allow a user access to a receptacle (230) to deposit the item.

S3. The system according to the preceding embodiment wherein the input section is configured to open the receptacle (230) to allow a user to access the receptacle and after a deposit of an item to close the receptacle (230).

S4. The system according to any of the 2 preceding embodiments wherein the input section (210) is configured to increase a bottom size of the receiving component (200) for depositing an item when the input section (210) is opened.

S5. The system according to any of the 3 preceding embodiments wherein the input section (210) is configured to assist the item to move into the receiving component (200) when the input section (210) is closing.

S6. The system according to any of the 4 preceding embodiments wherein the input section (210) is rotatably hinged to a housing (220) of the receiving component (200).

S7. The system according to any of the preceding embodiments wherein the receiving component (200) comprises at least one bottom lid (250) that is configured to open and deposit an item by gravity.

S8. The system according to the preceding embodiment wherein the bottom lid is hinged to a side of a bottom part of the receiving component (200).

S9. The system according to any of the preceding embodiments wherein the receiving component (200) comprises two bottom lids (250) that are configured to open and deposit an item by gravity.

S10. The system according to the preceding embodiment wherein the two bottom lids (250) are hinged at opposing sides of a bottom part of the receiving component (200).

S11. The system according to any of the preceding embodiments wherein the receiving component (200) further comprises a display (240) for a user.

S12. The system according to the preceding embodiment wherein the display (240) is configured to show a graphic user interface (GUI) when in use.

S13. The system according to any of the preceding embodiments wherein the receiving component (200) is controlled to provide access to a user at a first time and then block access to a user at a second time and/or open a bottom of the receiving component (200) at a third time.

S14. The system according to any of the preceding embodiments, wherein the at least one processing component further comprises at least one point-of-sale (POS) terminal.

S15. The system according to any of the preceding embodiments, wherein the at least one transaction processing component comprises at least one payment terminal.

S16. The system according to any of the preceding embodiments, wherein the at least one item to be returned comprises at least one item tag.

S17. The system according to any of the preceding embodiments, wherein the at least one item tag comprises at least one of:
a. NFC tag,
b. Smart tag,
c. RFID passive tag,
d. QR code,
e. Bar code,
f. Text tags,
g. Smart URL tags, and
h. URI tags.

S18. The system according to any of the preceding embodiments, wherein the system further comprises at least one base unit.

S19. The system according to the preceding embodiment, wherein the at least one base unit comprise at least one tag generating component configured to generate at least type of item tag.

S20. The system according to the preceding embodiments and with features of embodiment S5, wherein the tag generating component is further configured to encode the at least one item tag with at least one item data.

S21. The system according to the preceding embodiment, wherein the at least one item data comprises a monetary value of the at least one item to be returned, preferably a float and/or integer data type.

S22. The system according to any of the 2 preceding embodiments, wherein the at least one item data comprises a depreciation value of the at least one item to be returned, preferably a float and/or integer data type.

S23. The system according to any of the 3 preceding embodiments, wherein the at least one item data comprises at least one condition of return, preferably a string data type.

S24. The system according to any of the 4 preceding embodiments, wherein the at least one item data comprises at least one item identification data, preferably a float, integer, a pattern, or string datatype or a combination thereof.

S25. The system according to any of the preceding embodiments and with features of embodiment S6, wherein the at least one base unit is further configured to autonomously and/or semi-autonomously install the at least one item tag to the respective at least one item.

S26. The system according to any of the preceding embodiments, wherein the system comprises at least one server, wherein the at least one server comprises at least one of
a. a local, and
b. a remote server.

S27. The system according to any of the preceding embodiments and with features of embodiment S5, wherein the at least one base unit is configured to transmit the item data to the at least one server.

S28. The system according to any of the preceding embodiments, wherein the system is further configured to store the item data on at least one server storage component.

S29. The system according to the preceding embodiment, wherein the system comprises the at least one server storage component.

S30. The system according to any of the preceding embodiments and with features of embodiments S5 and S14, wherein the at least one base unit comprises at least one base unit storage component configured to exchange data with the at least one server.

S31. The system according to any of the preceding embodiments and with features of embodiment S7, wherein the at least one tag generating component comprises at least one computing unit configured to execute machine learning techniques, preferably supervised and/or semi supervised learning.

S32. The system according to the preceding embodiment, wherein the at least one tag generating component is configured to predict item data based on a historic data.

S33. The system according to the preceding embodiment, wherein the system is configured to automatically retrieve the historic data from an existing knowledgebase.

S34. The system according to any of the preceding embodiments and with features of embodiment S2, wherein the at least one PoS terminal is configured to automatically read the item tag.

S35. The system according to the preceding embodiment, wherein the at least one PoS terminal comprises at least one reader configured to read the item tag.

S36. The system according to the preceding embodiment, wherein the at least one reader comprises at least one of:
a. RFID reader,
b. NFC reader,
c. optical scanner,
d. pen type reader, and
e. laser scanners.

S37. The System according to any of the preceding embodiments, wherein each processing component comprises at least one computing unit, wherein each of the at least one computing unit comprises at least one storage component.

S38. The system according to the preceding embodiment, wherein each processing component is configured to access to the eat least one computing unit comprising at least one processing component.

S39. The system according to the 2 preceding embodiments, wherein at least one of the at least one computing unit and at least one of the at least one storage component are integrated into a single device.

S40. The system according to any of the preceding embodiments and with features of embodiments S2 or S22, wherein at least one of the at least one PoS terminal comprises at least one processing component, wherein at least one of the least one PoS terminal is configured to access at least one of the at least one processing component.

S41. The system according to the preceding embodiment, wherein at least one of the at least one processing component and at least one of the at least one PoS terminal are integrated into a single device.

S42. The system according to any of the preceding embodiments and with feature of embodiment S23, wherein the at least one reader is configured to transmit the item data to the at least one processing component.

S43. The system according to the preceding embodiment and with features of embodiment S23, wherein the at least one reader and the at least one processing component are integrated in the same device and configured to bidirectionally exchange data.

S44. The system according to any of the 2 preceding embodiments, wherein the at least one reader is configured to transmit item data to the at least one processing component.

S45. The system according to the preceding embodiment, wherein the at least one reader is configured to use at least one communication protocol comprising at least one of:
a. Bluetooth,
b. WLAN,
c. Zig-bee,
d. RFID,
e. NFC, and
f. Z-wave.

S46. The system according to any of the preceding embodiments, wherein the at least one processing component is configured to automatically generate at least one reimburse-value.

S47. The system according to the preceding embodiment, wherein the at least one processing component is configured to automatically generate at least one reimburse-value based on the item data.

S48. The system according to any of the 2 preceding embodiments and with features of embodiment S14, wherein the processing component is further configured to retrieve at least portion of item data from the at least one server.

S49. The system according to any of the preceding embodiments, wherein the system further comprises at least one issuing component.

S50. The system according to any of the preceding embodiments and with features of embodiments S34 or S35, wherein the at least one processing component is further configured to transmit the at least one reimburse-value to the at least one issuing component.

S51. The system according to any of the preceding embodiments and with features of embodiments S34 or S35, wherein the at least one processing component is configured to store the at least one reimburse-value on the at least one server storage component.

S52. The system according to any of the preceding embodiments and with features of embodiment S37, wherein the at least one issuing component is configured to enable at least one bank transaction.

S53. The system according to any of the preceding embodiments and with features of embodiment S37, wherein the at least one issuing component further comprises an encrypted communication protocol.

S54. The system according to any of the preceding embodiments, wherein the system is configured to enable the issuing component access to at least portion of the item data stored on the server storage component.

S55. The system according to any of the preceding embodiments and with features of embodiments S14 and S37, wherein the at least one issuing component is configured to retrieve the at least one reimburse-value from the at least one server storage component.

S56. The system according to any of the preceding embodiments and features of embodiments S3 and S34, wherein the system is further configured to transmit the at least one reimburse-value to the at least one payment terminal.

S57. The system according to the preceding embodiments, wherein the at least one reimburse-value is transmitted to the at least one payment terminal by means of the at least one processing component reimburse-value.

S58. The system according to embodiment S43 and with features of embodiment S2, S34 and S37, wherein the at least one issuing component is configured to transmit the at least one reimburse-value to the at least one payment terminal.

S59. The system according to any of the preceding embodiments and with features of embodiments S3 and S37, wherein the at least one issuing component is configured to enable a data exchange with the at least one payment terminal, preferably via the encrypted communication protocol.

S60. The system according to any of the preceding embodiments and with features of embodiment S3, wherein the at least one payment terminal comprises at least one operating system.

S61. The system according to any of the preceding embodiments and with features of embodiment S3, wherein the at least one payment terminal comprises at least one user interface.

S62. The system according to any of the preceding embodiments and with features of embodiment S3, wherein the at least one payment terminal comprises at least one user terminal.

S63. The system according to the preceding embodiment, wherein the at least one user terminal is configured to read at least one of:
a. Credit card,
b. debit card,
c. EMV card,
d. NFC card,
e. RFID card,
f. E-wallets,
g. QR code,
h. Barcode,
i. Google pay, and
j. Apply pay.

S64. The system according to any of the preceding embodiments, wherein the system is further configured to run a payment terminal application on a PC or mobile device.

S65. The system according to any of the preceding embodiments and with features of embodiments S51, wherein the system is configured to transmit the at least one reimburse-value to the at least one user terminal.

S66. The system according to any of the preceding embodiments and features of embodiment S3, wherein the at least one payment terminal comprises a money outlet.

S67. The system according to any of the preceding embodiments, wherein the money outlet is configured to dispense cash/coins at least equal to the amount of the at least one reimburse-value.

S68. The system according to any of the preceding embodiments and with features of embodiment S3 and S51, wherein the at least one payment terminal is further configured to extract one user ID from the at least one user terminal.

S69. The system according to any of the preceding embodiments and with features of embodiments S3 and S37, wherein the at least one payment terminal is configured to transmit the user ID to the at least one issuing component.

S70. The system according to any of the preceding embodiments and with features of embodiment S3 and S37, wherein the at least one payment terminal is configured to transmit the user ID associated with the at least one reimburse-value to the at least one issuing component.

Below, method embodiments will be discussed. These embodiments are abbreviated by the letter “M” followed by a number. Whenever reference is herein made to “method embodiments”, these embodiments are meant.

M1. A method for automatically triggering a transaction, the method comprising:
generating data related to at least one item to be returned,
processing the data related to the at least one item to be returned,
generating at least one transaction data related to the item to be returned, and
processing the at least one at least one transaction data related to the item to be returned.

M2. The method according to the preceding embodiment, wherein the step of processing the data related to at least one item to be returned comprises extracting an item data of the at least one item to be returned.

M3. The method according to the preceding embodiment wherein the receiving component comprises an input section that is configured to allow a user access to a receptacle to deposit the item.

M4. The method according to the preceding embodiment wherein the input section is configured to open the receptacle to allow a user to access the receptacle and after a deposit of an item to close the receptacle.

M5. The method according to any of the 2 preceding embodiments wherein the input section is configured to increase a bottom size of the receiving component for depositing an item when the input section is opened.

M6. The method according to any of the 3 preceding embodiments wherein the input section is configured to assist the item to move into the receiving component when the input section is closing.

M7. The method according to any of the 4 preceding embodiments wherein the input section is rotatably hinged to a housing of the receiving component.

M8. The method according to any of the preceding embodiments wherein the receiving component comprises at least one bottom lid that is configured to open and deposit an item by gravity.

M9. The method according to the preceding embodiment wherein the bottom lid is hinged to a side of a bottom part of the receiving component.

M10. The method according to any of the preceding embodiments wherein the receiving component comprises two bottom lids that are configured to open and deposit an item by gravity.

M11. The method according to the preceding embodiment wherein the two bottom lids are hinged at opposing sides of a bottom part of the receiving component.

M12. The method according to any of the preceding embodiments wherein the receiving component further comprises a display for a user.

M13. The method according to the preceding embodiment wherein the display is configured to show a graphic user interface (GUI) when in use.

M14. The method according to any of the preceding embodiments wherein the receiving component is controlled to provide access to a user at a first time and then block access to a user at a second time and/or open a bottom of the receiving component at a third time.

M15. The method according to any of the preceding method embodiments, wherein the at least one item to be returned comprises at least one item tag.

M16. The method according to any of the preceding method embodiments, wherein the at least one item tag comprises at least one of:
NFC tag,
Smart tag,
RFID passive tag,
QR code,
Bar code,
Text tags,
Smart URL tags, and
URI tags.

M17. The method according to the preceding embodiment, wherein the method comprises generating at least one type of item tag by means of at least one tag generating component comprise by at least one base unit.

M18. The method according to the preceding embodiment, wherein the method comprises encoding the at least one item tag with at least one item data using the at least one tag generating component.

M19. The method according to the preceding embodiment, wherein the at least one item data comprises a monetary value of the at least one item to be returned, preferably a float and/or integer data type.

M20. The method according to any of the preceding method embodiments, wherein the at least one item data comprises a depreciation value of the at least one item to be returned, preferably a float and/or integer data type.

M21. The method according to any of the preceding method embodiments, wherein the at least one item data comprises at least one condition of return, preferably a string data type.

M22. The method according to any of the preceding method embodiments, wherein the at least one item data comprises at least one item identification data, preferably a float, integer, a pattern, or string datatype or a combination thereof.

M23. The method according to any of the preceding method embodiments, wherein the method comprises autonomously and/or semi-autonomously installing the at least one item tag to the respective at least one item.

M24. The method according to the preceding embodiment, wherein the method comprises installing the at least one item tag to the respective at least one time using the at least one base unit.

M25. The method according to any of the preceding method embodiments, wherein the method comprises transmitting the item data to at least one server.

M26. The method according to the preceding method embodiments, the at least one server comprises at least one of
a. a local, and
b. a remote server.

M27. The method according to any of the preceding method embodiments, wherein the method comprises storing the item data on at least one server storage component.

M28. The method according to any of the preceding method embodiments, wherein the method comprises exchanging data with the least one server.

M29. The method according to the preceding embodiment, wherein the method comprises exchanging data between the least one server and the at least one base unit.

M30. The method according to the preceding embodiment, wherein the at least one base unit comprises at least one base unit storage component and wherein the method comprises exchanging data between the at least one server and the at least one base unit storage component.

M31. The method according to any of the preceding method embodiments, wherein the method comprises executing machine learning techniques, preferably supervised and/or semi supervised learning.

M32. The method according to the preceding embodiment, wherein the method comprises executing machine learning techniques via at least one computing unit.

M33. The method according to the preceding embodiment, wherein the at least one computing unit is comprised by the at least one tag generating component.

M34. The method according to the preceding embodiment, wherein the method comprises predicting item data based on historic data.

M35. The method according to the preceding embodiment, wherein the method comprises automatically retrieving the historic data from an existing knowledgebase.

M36. The method according to any of the preceding method, wherein the method comprises automatically reading the item tag by means of at least one PoS terminal.

M37. The method according to the preceding embodiment, wherein the at least one PoS terminal comprises at least one reader configured to read the item tag.

M38. The method according to the preceding embodiment, wherein the at least one reader comprises at least one of:
RFID reader,
NFC reader,
optical scanner,
pen type reader, and
laser scanners.

M39. The method according to any of the preceding method embodiments, wherein the method comprises accessing at least one computing unit comprising at least one processing component.

M40. The method according to any of the preceding method embodiments and with features of embodiments M24, wherein at least one of the at least one PoS terminal comprises at least one processing component, wherein the method comprises at least one of the at least one processing component.

M41. The method according to any of the preceding method embodiments and with features of embodiment M24 and M25, wherein the method comprises transmitting the item data from at least one reader to the at least one processing component.

M42. The method according to the preceding embodiment, wherein the at least one reader is configured to use at least one communication protocol comprising at least one of:
Bluetooth,
WLAN,
Zig-bee,
RFID,
NFC, and
Z-wave.

M43. The method according to any of the preceding method embodiments and with features of embodiment M24, wherein the method comprises automatically generating at least one reimburse-value via the at least one processing component.

M44. The method according to the preceding embodiment, wherein the at least one reimburse-value is based on the item data.

M45. The method according to any of the 2 preceding embodiments and with features of embodiment M24, wherein the method comprises retrieving at least one portion of item data from the at least one server via the at least one processing component.

M46. The method according to any of the preceding method embodiments, wherein the method comprises transmitting the at least one reimburse-value to at least one issuing component via the at least one processing component.

M47. The method according to any of the preceding method embodiments, wherein the method comprises storing the at least one reimburse-value on the at least one server storage component via the at least one processing component.

M48. The method according to any of the preceding method embodiments, wherein the method comprises enabling at least one bank transaction via the at least one issuing component.

M49. The method according to any of the preceding method embodiments, wherein method comprising encrypting data by means of an encrypted communication protocol comprise by the at least one issuing component.

M50. The method according to any of the preceding method embodiments, wherein the method comprising enabling the issuing component access to at least portion of the item data stored on the server storage component.

M51. The method according to any of the preceding method embodiments, wherein the method comprises retrieving the at least one reimburse-value from the at least one server storage component via the at least one issuing component.

M52. The method according to any of the preceding method embodiments, wherein the method comprises transmitting the at least one reimburse-value to the at least one payment terminal.

M53. The method according to the preceding method embodiments, wherein the at least one reimburse-value is transmitted to the at least one payment terminal by means of the at least one processing component.

M54. The method according to any of the preceding method embodiments, wherein the method comprises transmitting the at least one reimburse-value to the at least one payment terminal via the at least one issuing component.

M55. The method according to any of the preceding method embodiments, wherein the method comprises enabling a data exchange with the at least one payment terminal, preferably via the encrypted communication protocol, via the at least one issuing component.

M56. The method according to any of the preceding method embodiments, wherein the at least one payment terminal comprises at least one operating system.

M57. The method according to any of the preceding method embodiments, wherein the at least one payment terminal comprises at least one user interface.

M58. The method according to any of the preceding method embodiments, wherein the at least one payment terminal comprises at least one user terminal.

M59. The method according to the preceding embodiment, wherein the method comprises reading via at least one user terminal at least one of:
Credit card,
debit card,
EMV card,
NFC card,
RFID card,
E-wallets,
QR code,
Barcode,
Google pay, and
Apply pay.

M60. The method according to any of the preceding method embodiments, wherein the method comprises running a payment terminal application on a PC or mobile device.

M61. The method according to any of the preceding method embodiments, wherein the method transmitting the at least one reimburse-value to the at least one user terminal.

M62. The method according to any of the preceding method embodiments, wherein the at least one payment terminal comprises a money outlet.

M63. The method according to any of the preceding method embodiments, wherein the money outlet is configured to dispense cash/coins at least equal to the amount of the at least one reimburse-value.

M64. The method according to any of the preceding method embodiments, wherein the at least one payment terminal is further configured to extract one user ID from the at least one user terminal.

M65. The method according to any of the preceding method embodiments, wherein the at least one payment terminal is configured to transmit the user ID to the at least one issuing component.

M66. The method according to any of the preceding method embodiments, wherein the at least one payment terminal is configured to transmit the user ID associated with the at least one reimburse-value to the at least one issuing component.

M67. The method according to any of the preceding method embodiments, wherein the method comprises
a. retrieving information related to a user, and
b. executing at least one online currency transferring,
c. wherein the method comprises using the information related to the user to transfer an amount of currency from a bank account to a user bank account.

M68. The method according to the preceding embodiment, wherein the bank account is different from the user bank account.

M69. The method according to any of the 2 preceding embodiments, wherein the method further comprises
a. prompting the user to introduce an NFC bank car into a bank terminal, and
b. initiating a transaction.

M70. The method according to the preceding embodiment, wherein the transaction comprises at least one of
a. a reversal payment, and
b. a regular payment.

M71. The method according to any of the preceding method embodiments, wherein the method further comprises retrieving bank card data such as card number, card issuer bank, validation date.

M72. The method according to any of the preceding method embodiment, wherein the method further comprises processing the bank card data, wherein processing the bank card data comprises matching the bank card data collected with the user's name and IBAN.

M73. The method according to the preceding embodiment, wherein the method comprises generating matches between the bank card data collected with the user's name and IBAN, wherein in case of no matches, the method comprises
a. generating a request, and
b. sending the request to the card issuer bank.

M74. The method according to the preceding embodiment, wherein the method comprises receiving from the card issuer bank data based upon the request, wherein the card issuer data comprises further information for connecting the user's bank card and IBAN.

M75. The method according to the preceding embodiment, wherein the method comprises saving the user's data and proceeding to perform any of the steps according to any of the preceding method embodiments.

M76. The method according to any of the preceding method embodiment, wherein the method comprises controlling the system according to any of the preceding system embodiment to execute the method according to any of the preceding method embodiments.

Below, use embodiments will be discussed. These embodiments are abbreviated by the letter “U” followed by a number. Whenever reference is herein made to “use embodiments”, these embodiments are meant.

U1. Use of the system according to any of the preceding system embodiments for carrying out the method according to any of the preceding method embodiments.

Below, program embodiments will be discussed. These embodiments are abbreviated by the letter “P” followed by a number. Whenever reference is herein made to “program embodiments”, these embodiments are meant.

P1. A computer program product comprising instructions, which, when the program is executed by a user terminal device, causes a user terminal device to perform the method steps according to any method embodiment, which have to be executed on the user terminal device, wherein the user device is according to any system embodiment that comprises a user terminal device that is compatible to said method embodiment.

P2. A computer program product comprising instructions, which, when the program is executed by a combination of a server and user terminal device, cause the server and the user terminal device to perform the method steps according to any method embodiment, which have to be executed on the server and the user terminal device, wherein the user device and the server is according to any system embodiment that comprises a sever and/or the user device that is compatible to said method embodiment.

P3. A computer program product comprising instructions, which, when the program is executed by a server, cause the server to perform the method steps according to any method embodiment, which have to be executed on the server, wherein the server is according to any system embodiment that comprises a server that is compatible to said method embodiment.

P4. A computer program product comprising instructions, which, when the program is executed by a processing component, cause the processing component to perform the method steps according to any method embodiment, which have to be executed on the processing component, wherein the processing component is according to any system embodiment that comprises a processing component that is compatible to said method embodiment.

The present invention will now be described with reference to the accompanying drawings, which illustrate embodiments of the invention. These embodiments should only exemplify, but not limit, the present invention.

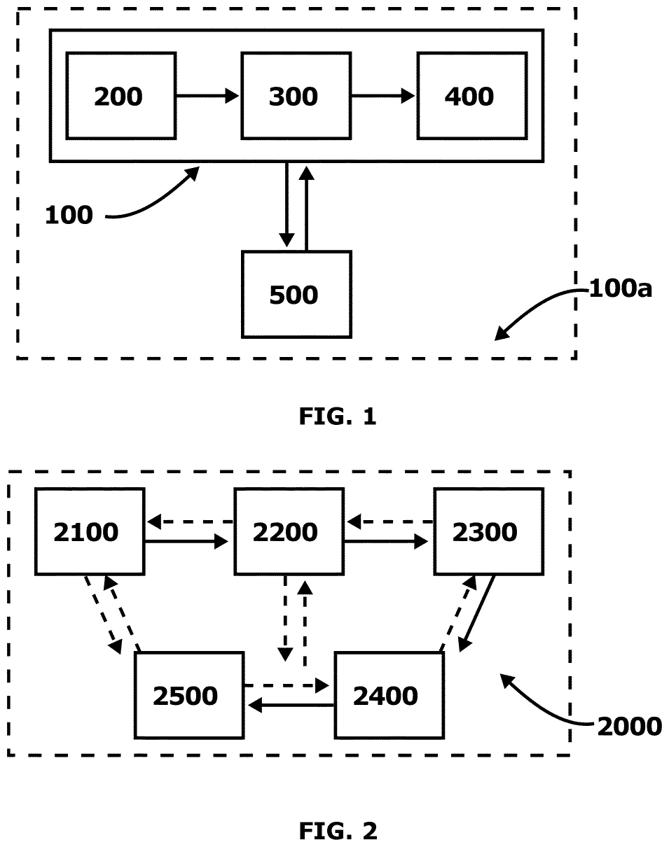

FIG. 1 schematically depicts a system for an automated triggering of transactions according to embodiments of the present invention;

FIG. 2 schematically depicts an application example of the system 100 according to embodiments of the present invention;

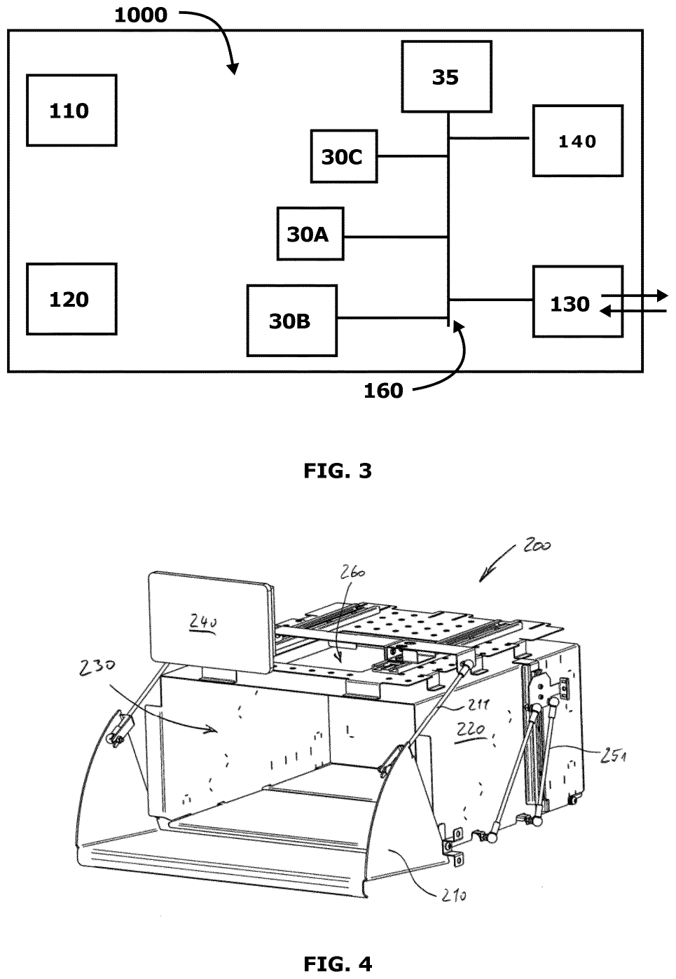

FIG. 3 depicts a schematic of a computing device 1000;

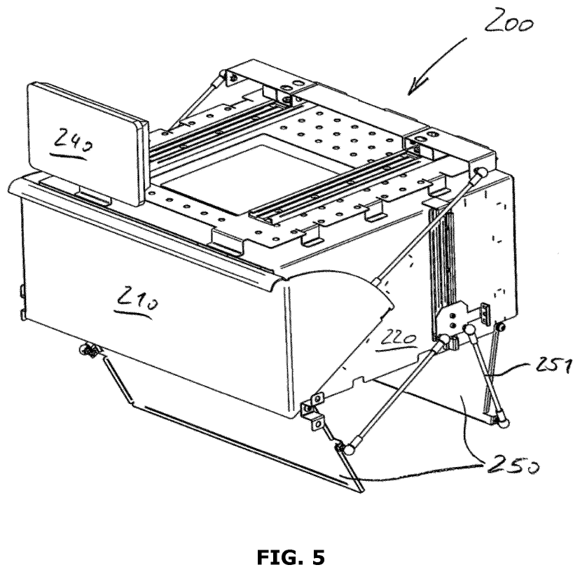

FIG. 4 exemplifies a perspective view onto a receiving component 200 during a receiving stage; and

FIG. 5 exemplifies a perspective view onto the same receiving component 200 as in FIG. 4 during a clearing stage.

In the following description, a series of features and/or steps are described. The skilled person will appreciate that unless explicitly required and/or unless requires by the context, the order of features and steps is not critical for the resulting configuration and its effect. Further, it will be apparent to the skilled person that irrespective of the order of features and steps, the presence or absence of time delay between steps can be present between some or all of the described steps.

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

FIG. 1 schematically depicts a system 100 for an automated triggering of transactions according to embodiments of the present invention. In simple terms, the system 100 may comprise a receiving component 200, a processing component 300 and a transaction processing component 400.

Additionally or alternatively, the system 100 may also be configured to establish a communication with a server 500. In one embodiment, the communication between the system 100 and the server 500 may be a bidirectional communication. Moreover, in some embodiments of the present invention, the server 500 may also comprise a plurality of servers 500, wherein at least one of the servers 500 may be a remote server.

It also should be understood that at least one or at least partially one of the servers 500 may comprise at least a local module in the system 100. This is schematically depicted in FIG. 1 as system 100a, wherein the server 500 is shown as part of the system 100a indicated by the dashed line. However, it should further be understood that the system 100a may partially comprise the server 500, and that even in embodiments wherein the system 100a (totally or partially) comprises the server 500, the server 500 may still be either a local server, a remote server, or any combination thereof.

The receiving component 200 may also comprise a plurality of receiving components 200. In simple terms, the receiving component 200 may comprise a receptacle (not shown) for receiving an item to be returned. The receptable may comprise a movable frontal section configure to grant access to user to deposit the item to return into the receptacle. In some embodiment, the movable frontal section may comprise an automated movable frontal section configured to be activated to grant access to the user to deposit the item to returned into the receptacle and subsequently be activated to isolate the receptacle from the surrounding and to allow the system 100 to further process the item to be returned deposited in the receptacle. Moreover, the receptacle may comprise one or more sensor configured to perform a plurality of steps such as, but not limited to, identifying the type of item to returned that is deposited in the receptacle, the number of items deposited, their value, materials. The receiving component 200 may also comprise a housing (depicted in FIGS. 4 and 5) configured to allocate the receptacle and sensors comprised by the receiving component 200.

Furthermore, the receiving component 200 may comprise one or more automated mechanical tweezers comprising a plurality of forms, which may be configured to grab and transfer the item to be returned from the receptacle into other components of the system 100. Additionally or alternatively, the receiving component 200 may comprise a conveyor belt (not shown) configured to receive and transport the item to be returned from the receptacle to other components of the system 100. In another embodiment, the receiving component may comprise a combination of mechanical tweezer and conveyor belt. In some embodiments, the receiving component 200 may also comprise other type of mechanisms to receive the item to be returned, such as, for example, a vacuum mechanism that may allow to suck in the item to be returned.

In more simple words, the receiving component 200 may be configured to receive one or more items to be returned. An item to be returned may, for instance, be an empty container such as the container for a liquid, e.g. a bottle, a cup, or any other type of item that may be required to be return after its content has been exhausted. In another embodiment, the item to be returned may also comprise an item prior to use that for a plurality of conditions may be required to be returned such as for example a defect in the product, unforeseen expiration date, etc.

Moreover, the system 100 may also comprise one or more processing component 300 configured to process the one or more items to be returner. In one embodiment, the processing component 300 may also be configured to process data related to the at least one item to be returned. For instance, but not limited to, processing the item to be returned may comprise identifying the type of item to be return, the material comprised by the item to be return, the weight of the item to be return, the number of items to be returned. Processing the data related to at least one item to be returned may comprise associating each of the characteristics identified or generated during the processing of the one or more item to returned to a standard subsequent number of actions that may comprise, inter alia, a next physical processing step of the item to be returned within the system 100 and/or a remote processing step such a data transferring, which may be used to automatically triggering a plurality of further steps, such as for example, for automatically triggering a transaction. Such steps may automatically be executed by the processing component 300, wherein the processing component may autonomously operate without any further input needed from the user.

Furthermore, the system 100 may also comprise a transaction processing component 400. It should be understood that the transaction processing component 400 may comprise a plurality of transaction processing modules and/or sub-components, such as, for example, at least one point-of-sale (PoS) terminal and/or at least one payment terminal.

It should also be understood that the system 100 may be configured to process a plurality of characteristics comprised by the item to be returned. For instance, inter alia, the item to be returned may comprise one or more item tag. An item tag is term intended to refer to an identifier comprise by the item to be returned that may comprise a plurality of different data set information that can be used by the system 100. For example, but not limited to, the one item tag may comprise one or more of NFC tag, Smart tag, RFID passive tag, QR code, Bar code, Text tags, Smart URL tags, and URI tags. Such an identifier may comprise more than one identifier, for example, a float, integer, a pattern, or string datatype or a combination thereof.

Additionally or alternatively, the system 100 may be configured to generate one item tag to be attached to the item to be returned for processes wherein further information may be required to be provided. For this purpose, the system 100 may further comprise at least one base unit comprising one or more tag generating component (both not shown) configured to generate at least type of item tag and to autonomously and/or semi-autonomously install the at least one item tag to the respective item to be returned. Such an item tag may be used to contain data as regards the item to be returned. Thus, the tag generating component may further be configured to encode the at least one item tag with at least one item data, for instance, data as regards the type of item, size, value, materials, etc. Moreover, the at base unit may also be configured to transmit the item data to the at least one server.

In some embodiments, the one or more item data may also comprise a monetary value information related to the item to be returned, such as, for example, a float, an integer data type. In another embodiments, the one or more item data may additionally or alternatively comprise a depreciation value of the at least one item to be returned, and/or one or more condition of return such as a string data type.

FIG. 4 shows an example of a receiving component 200. As mentioned and apparent from this figure it can have a housing or a casing 220 defining a receptacle 230 or space for receiving any items or goods. The kind and shape are just an example for a solid metal-based housing 220. The housing can comprise a number of interfaces or couplings for other components, such as a display 240, a movable frontal section 210 or lid 210, actuators 210 or sensors (not shown) etc.

The receiving component 220 can be covered by a pleasant and/or decorative cover, such as plastic covers etc. so that the structure shown is hidden to a user.

In the embodiment shown in FIG. 4, the receiving component 200 is shown in an open state that would allow a user to deposit an item to be returned. The receptacle 230 can be formed to allow one or more items to be deposited and can be of general shape or of more specific shape adapted to the item.

The display can have a graphic user interface (GUI) for providing information about the process, the kind of item, the number of items, the amounts involved, a proper handling and money transfer etc. It can also have softkeys for a user to control the process and/or select options.

The frontal section 210 can be a three-dimensional lid that can be turned around a hinge or several hinges and that can enlarge a bottom surface of the casing. In case a user deposits an item onto this part of the frontal section 210 in the opened state, it can then close and transfer the item to the interior of the receiving component 200.

In the embodiment shown, the frontal section is held and actuated by first arms 211 that can be arranged at the two opposing ends of the frontal section 210 to provide a better stability.

A window 260 can be provided for allowing a sensor, such as a camera (not shown) to detect the item, its shape, its condition and/or the number thereof etc. by image recognition. Other sensors, such as capacitive sensors, inductive sensors and particularly an RFID reader, NFC reader, optical scanner, pen type reader, and/or a laser scanner.

The window 260 can be also provided at other places or more than one window 260 can be provided.

FIG. 5 shows the same receiving component 200 as in the previous example in a different condition. In the condition shown, the frontal section 210 is closed and not accessible to a user. However, bottom lids 250 or just one larger bottom lid (not shown) are in an open condition so that an item in the receiving component 200 is able to fall into a larger container (not shown) after his has been detected and/or scanned. The bottom lid(s) 250 advantageously define(s) a large if not entire part of the receiving component's bottom so as to ensure that an item or a number of items don't remain int the receiving component 200 once the bottom lid(s) are opened. Two bottom lids 250 have the advantage to use lesser space when opened.

The bottom lid(s) 250 can be hinged to the casing 220 and they can be supported by bottom lid arms 251 as shown.

FIG. 2 schematically depicts an application example of the system 100 according to embodiments of the present invention. In simple terms, the system 100 depicted in FIG. 1 may be used to implement a method 2000 for automatically triggering a transaction, wherein the system 100 may be configured to perform plurality of steps as mentioned above that may be related to the method for automatically triggering the transaction.

In simple words, the method 2000 may comprise a plurality of different steps that will be detailed below. It should be understood that whenever a step is referred to as first step, second step and/or third step, it does not limit the steps to be executed in the recited order. In some embodiments, an intermediate step may take place between two subsequent steps and may be referred to with a higher subsequent number and/or an alternative conceptual reference number. It should be understood that in some embodiments, some steps may be omitted, simplified and/or cancelled.

The method 2000 may comprise a first step 2100, which may comprise generating data related to at least one item to be returned. Moreover, the method 2000 may comprise a second step 2200, which may comprise processing the data related to the at least one item to be returned. Additionally or alternatively, the method 2000 may further comprise a third step 2300 and a fourth step 2400, which may comprise generating at least one transaction data related to the item to be returned, and processing the at least one at least one transaction data related to the item to be returned, respectively.

The fourth step 2400 may also comprise extracting an item data of the at least one item to be returned, which may be automatically trigger when an item to be returned is received by the receiving component 200 (see. FIG. 1) and said item data be extracted from one or more item tag comprised by the item to be returned, which in some cases may comprise one or more of NFC tag, Smart tag, RFID passive tag, QR code, Bar code, Text tags, Smart URL tags, and URI tags.

Moreover, the method 2000 may also comprise a fifth step 2500, which may comprise generating and/or autonomously (or semi-autonomously) installing at least one type of item tag by means of the at least one tag generating component comprise by at least one base unit onto an item to be returned, as described in FIG. 1. Furthermore, in the fifth or another step (not depicted) the method 2000 may encode data related to item to be returned into the at least one item tag, which the method 2000 may comprise implementing such a step by means of the one tag generating component. The encoded data related to the item to be returned may comprise, inter alia, a monetary value data, a depreciation value data, one or more conditions of return and/or one or more item identification data or any combination thereof.

In a further embodiment, the method 2000 may comprise transmitting to one or more server item data extracted by means of step 2400 and/or at least storing the extracted item data in a local server and/or a server storage component.

All the above-mentioned steps may be executed by means of machine learning techniques, for which purpose, the method 2000 may comprise implementing, for instance, a supervised and/or a semi supervised learning, which may be executed via one or more computing device as detailed below in FIG. 3.

Additionally or alternatively, the method 2000 may use the extracted item data to predict future item data, wherein the method 2000 may further comprise predicting the item data based on historic data. In some instances, the method 2000 may retrieve such historic data from an existing knowledgebase which may be a remote knowledgebase and/or comprise by the one or more server depicted in FIG. 1.

In more simple words, the method 2000 may comprise prompting a user to deposit one or more item to be returned into a receiving component 200, wherein the method may automatically trigger reading an item tag comprise by the one or more item to be returned, for example, by means of a PoS terminal, which may comprise a dedicated reader configured to read the item tag such as a RFID reader, NFC reader, optical scanner, pen type reader, and laser scanners. Subsequently, the method 2000 may access one or more computing device units which may be comprise by the system 100 and/or the computing device 1000.

Afterwards, the method 2000 may comprise automatically generating at least one reimburse-value by means of the at least one processing component, wherein the at least one reimburse-value may be based the extracted item data, and transmit said one or more reimburse-value to the one or more server and/or to at least one issuing component, which may later be retrieved by the method 2000. Alternatively or additionally, the method 2000 may store the at least one reimburse-value on the at least one server storage component and/or the one or more servers, which may be locally stored in components of the system 100 and/or remotely. Subsequently the method 2000 may automatically enable and trigger one or more bank transaction which may comprise encrypting data related to the transaction by means of an encrypting protocol.

In order to execute all the above-mentioned steps, the method 2000 may comprise using an operating system, which may comprise an interaction with at least one user interface and one user terminal, which may serve to the method 2000 for prompting actions from a user. Moreover, by means of said operating system the method 2000 may read facilitated by the at least one user terminal a plurality of different payment options such as credit, debit card, EMV card, NFC card, RFID card, E-wallets, QR code, Barcode, Google pay, and Apply pay.

In some embodiments, the method 2000 may perform at least partially the above-mentioned steps on a PC or a mobile device or directly control a money outlet to dispense cash/coins at least equal to the amount of the at least one reimburse-value.

Additionally or alternatively, the method 2000 may extract one user ID, for example, from the at least one user terminal and transmit the user ID to the at least one issuing component, wherein the user ID may comprise user data associated with the at least one reimburse-value and wherein based on these data the method 2000 may automatically trigger a transaction, which may further comprise retrieving information related to the user and executing one or more online currency transferring based on the information related to the user to transfer an amount of currency from a bank account to a user bank account. At this point, the method 2000 may prompt the user to introduce an NFC bank car into a bank terminal to automatically initiate the transaction which may for example be a reversal payment and/or a regular payment. In order to successfully execute the transaction, the method 2000 may further comprise automatically executing further steps in the background, such as, but not limited to, retrieving bank card data such as card number, card issuer bank, validation date, processing the bank card data, wherein processing the bank card data may comprise matching the bank card data collected with the user's name and IBAN and/or generating matches between the bank card data collected with the user's name and IBAN, wherein in case of no matches, generating a request, and sending the request to the card issuer bank.

Once all of the above-mentioned have successfully come to a conclusion, the method 2000 may display a successful transaction conclusion message to the user. It should be understood that in case of error during any of the above-mentioned steps, the method 2000 may display one or more error messages to the user, prompting the user to execute some actions or providing to the user with any further instructions.

FIG. 3 depicts a schematic of a computing device 1000. The computing device 1000 may comprise a computing unit 35, a first data storage unit 30A, a second data storage unit and a third data storage unit 30C. It should be understood that the computer device 1000 may be at least partially be comprised by the system 100 and further that the system 100 may comprise one or more computing devices 1000, wherein the one or more computing devices 1000 may be partially or totally comprise by the system 100 and/or partially or totally a remote device.

In more simple words, the computing device 1000 can be a single computing device or an assembly of computing devices. The computing device 1000 can be locally arranged or remotely, such as a cloud solution.

On the different data storage units 30 the different data can be stored, such as the genetic data on the first data storage 30A, the time stamped data and/or event code data and/or phenotypic data on the second data storage 30B and privacy sensitive data, such as the connection of the before-mentioned data to an individual, on the thirds data storage 30C.

Additional data storage can be also provided and/or the ones mentioned before can be combined at least in part. Another data storage (not shown) can comprise data specifying for instance, air temperature, rail temperature, position of blades, model of point machine, position of point machine and/or further railway network related information. This data can also be provided on one or more of the before-mentioned data storages.

The computing unit 35 can access the first data storage unit 30A, the second data storage unit 30B and the third data storage unit 30C through the internal communication channel 160, which can comprise a bus connection 160.

The computing unit 30 may be single processor or a plurality of processors, and may be, but not limited to, a CPU (central processing unit), GPU (graphical processing unit), DSP (digital signal processor), APU (accelerator processing unit), ASIC (application-specific integrated circuit), ASIP (application-specific instruction-set processor) or FPGA (field programmable gate array). The first data storage unit 30A may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

The second data storage unit 30B may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM). The third data storage unit 30C may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

It should be understood that generally, the first data storage unit 30A (also referred to as encryption key storage unit 30A), the second data storage unit 30B (also referred to as data share storage unit 30B), and the third data storage unit 30C (also referred to as decryption key storage unit 30C) can also be part of the same memory. That is, only one general data storage unit 30 per device may be provided, which may be configured to store the respective encryption key (such that the section of the data storage unit 30 storing the encryption key may be the encryption key storage unit 30A), the respective data element share (such that the section of the data storage unit 30 storing the data element share may be the data share storage unit 30B), and the respective decryption key (such that the section of the data storage unit 30 storing the decryption key may be the decryption key storage unit 30A).

In some embodiments, the third data storage unit 30C can be a secure memory device 30C, such as, a self-encrypted memory, hardware-based full disk encryption memory and the like which can automatically encrypt all of the stored data. The data can be decrypted from the memory component only upon successful authentication of the party requiring to access the third data storage unit 30C, wherein the party can be a user, computing device, processing unit and the like. In some embodiments, the third data storage unit 30C can only be connected to the computing unit 35 and the computing unit 35 can be configured to never output the data received from the third data storage unit 30C. This can ensure a secure storing and handling of the encryption key (i.e. private key) stored in the third data storage unit 30C.

In some embodiments, the second data storage unit 30B may not be provided but instead the computing device 1000 can be configured to receive a corresponding encrypted share from the database 60. In some embodiments, the computing device 1000 may comprise the second data storage unit 30B and can be configured to receive a corresponding encrypted share from the database 60.

It should also be understood that the one or more of the data storage units 30A, 30B and/or 30C may be comprise by the server 500 depicted in FIG. 1 and thus, one or more of the data storage units 30A, 30B and/or 30C may be a remote data storage unit and/or at least a partially remote data storage unit. In some embodiments, the data storage units may also be part of a cloud.

The computing device 1000 may comprise a further memory component 140 which may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM). The memory component 140 may also be connected with the other components of the computing device 1000 (such as the computing component 35) through the internal communication channel 160.

Further the computing device 1000 may comprise an external communication component 130. The external communication component 130 can be configured to facilitate sending and/or receiving data to/from an external device (e.g. backup device 10, recovery device 20, database 60). The external communication component 130 may comprise an antenna (e.g. WIFI antenna, NFC antenna, 2G/3G/4G/5G antenna and the like), USB port/plug, LAN port/plug, contact pads offering electrical connectivity and the like. The external communication component 130 can send and/or receive data based on a communication protocol which can comprise instructions for sending and/or receiving data. Said instructions can be stored in the memory component 140 and can be executed by the computing unit 35 and/or external communication component 130.

The external communication component 130 can be connected to the internal communication component 160. Thus, data received by the external communication component 130 can be provided to the memory component 140, computing unit 35, first data storage unit 30A and/or second data storage unit 30B and/or third data storage unit 30C. Similarly, data stored on the memory component 140, first data storage unit 30A and/or second data storage unit 30B and/or third data storage unit 30C and/or data generated by the computing unit 35 can be provided to the external communication component 130 for being transmitted to an external device or to the server 500 (see FIG. 1).

In addition, the computing device 1000 may comprise an input user interface 110 which can allow the user of the computing device 1000 to provide at least one input (e.g. instruction) to the computing device 1000. For example, the input user interface 110 may comprise a button, keyboard, trackpad, mouse, touchscreen, joystick and the like. Additionally or alternatively the input user interface 110 may also be configured to prompt a user to provide an input that the computing device 1000 may require.

Even additionally, the computing device 1000 may comprise an output user interface 120 which can allow the computing device 1000 to provide indications to the user. For example, the output user interface 110 may be a LED, a display, a speaker and the like. This output user interface 120 may be used to prompt the user provide the above-mentioned inputs.

In some embodiments, the input user interface 110 and the output user interface 120 may be integrated in one single device, e.g. a touchscreen.

The output user interface 120 and the input user interface 110 may also be connected through the internal communication component 160 with the internal component of the computing device 1000.

The processor may be singular or plural, and may be, but not limited to, a CPU, GPU, DSP, APU, or FPGA. The memory may be singular or plural, and may be, but not limited to, being volatile or non-volatile, such an SDRAM, DRAM, SRAM, Flash Memory, MRAM, F-RAM, or P-RAM.

The data processing device can comprise means of data processing, such as, processor units, hardware accelerators and/or microcontrollers. The data processing device 20 can comprise memory components, such as, main memory (e.g. RAM), cache memory (e.g. SRAM) and/or secondary memory (e.g. HDD, SDD). The data processing device can comprise busses configured to facilitate data exchange between components of the data processing device, such as, the communication between the memory components and the processing components. The data processing device can comprise network interface cards that can be configured to connect the data processing device to a network, such as, to the Internet. The data processing device can comprise user interfaces, such as:
output user interface, such as:
   screens or monitors configured to display visual data (e.g. displaying graphical user interfaces of railway network status),
   speakers configured to communicate audio data (e.g. playing audio data to the user),
input user interface, such as:
   camera configured to capture visual data (e.g. capturing images and/or videos of the user),
   microphone configured to capture audio data (e.g. recording audio from the user),
   keyboard configured to allow the insertion of text and/or other keyboard commands (e.g. allowing the user to enter text data and/or other keyboard commands by having the user type on the keyboard) and/or trackpad, mouse, touchscreen, joystick—configured to facilitate the navigation through different graphical user interfaces of the questionnaire.

The data processing device can be a processing unit configured to carry out instructions of a program. The data processing device can be a system-on-chip comprising processing units, memory components and busses. The data processing device can be a personal computer, a laptop, a pocket computer, a smartphone, a tablet computer. The data processing device can be a server, either local and/or remote. The data processing device can be a processing unit or a system-on-chip that can be interfaced with a personal computer, a laptop, a pocket computer, a smartphone, a tablet computer and/or user interface (such as the upper-mentioned user interfaces).

Reference numbers and letters appearing between parentheses in the claims, identifying features described in the embodiments and illustrated in the accompanying drawings, are provided as an aid to the reader as an exemplification of the matter claimed. The inclusion of such reference numbers and letters is not to be interpreted as placing any limitations on the scope of the claims.

The term “at least one of a first option and a second option” is intended to mean the first option or the second option or the first option and the second option.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1-16. (canceled)

17. A system for automatically triggering a transaction, the system comprising:
at least one receiving component configured to receive at least one item to be returned;
at least one processing component configured to:
process the at least one item to be returned, and
process data related to the at least one item to be returned; and
at least one transaction processing component configured to perform at least one transaction related to the item to be returned.

18. The system according to claim 17, wherein:
the at least one processing component further comprises at least one point-of-sale (PoS) terminal;
the at least one transaction processing component comprises at least one payment terminal; and
the at least one item to be returned comprises at least one item tag comprising at least one of:
an NFC tag,
a smart tag,
an RFID passive tag,
a QR code,
a bar code,
a text tag,
a smart URL tag, or
a URI tag.

19. The system according to claim 17, wherein the system further comprises at least one base unit comprising at least one tag generating component configured to:
generate at least one type of item tag; and
encode the at least one item tag with at least one item data comprising at least one of:
a monetary value of the at least one item to be returned,
a depreciation value of the at least one item to be returned,
at least one condition of return, or
at least one item data comprises at least one item identification data.

20. The system according to claim 19, wherein the at least one base unit is further configured to autonomously and/or semi-autonomously install the at least one item tag to the respective at least one item to be returned, wherein the system comprises at least one server comprising at least one of a local server or a remote server,
wherein the at least one base unit is configured to transmit the item data to the at least one server.

21. The system according to claim 19, wherein:
the system is further configured to store the item data on at least one server storage component;
the at least one base unit comprises at least one base unit storage component configured to exchange data with the at least one server;
the at least one tag generating component comprises at least one computing unit configured to execute machine learning techniques, preferably supervised and/or semi supervised learning; and
the at least one tag generating component is configured to predict item data based on a historic data.

22. The system according to claim 18, wherein the at least one PoS terminal is configured to automatically read the item tag, wherein the at least one PoS terminal comprises at least one reader configured to read the item tag, wherein the at least one reader comprises at least one of:
an RFID reader;
an NFC reader;
an optical scanner;
a pen type reader; or
a laser scanner.

23. The system according to claim 19, wherein the system is configured to transmit the item data to the at least one processing component and use at least one communication protocol comprising at least one of:
Bluetooth;
WLAN;
Zig-bee;
RFID;
NFC; or
Z-wave.

24. The system according to claim 21, wherein the system further comprises at least one issuing component, and the at least one processing component is configured to:
automatically generate at least one reimburse-value based on the item data;
retrieve at least portion of item data from the at least one server;
transmit the at least one reimburse-value to the at least one issuing component; and
store the at least one reimburse-value on the at least one server storage component.

25. The system according to claim 18, wherein the at least one payment terminal comprises at least one of:
a user interface; and
a user terminal configured to read at least one of a credit card, a debit card, an EMV card, an NFC card, an RFID card, an E-wallet, a QR code, a barcode, Google pay, or Apply pay;
wherein the at least one payment terminal is further configured to extract one user ID from the at least one user terminal and transmit the user ID to the at least one issuing component.

26. A method for automatically triggering a transaction, the method comprising:
generating data related to at least one item to be returned;
processing the data related to the at least one item to be returned;
generating at least one transaction data related to the item to be returned; and
processing the at least one at least one transaction data related to the item to be returned.

27. The method according to claim 26, wherein the processing the data related to at least one item to be returned comprises extracting an item data of the at least one item to be returned, and the at least one item to be returned comprises at least one item tag comprising at least one of:
an NFC tag;
a smart tag;
an RFID passive tag;
a QR code;
a bar code;
a text tag;
a smart URL tag; or
a URI tag.

28. The method according to claim 26, wherein the method comprises:
generating at least one type of item tag by means of at least one tag generating component comprised by at least one base unit;
encoding the at least one item tag with at least one item data using the at least one tag generating component, wherein the at least one item data comprises at least one of:
a monetary value of the at least one item to be returned,
a depreciation value of the at least one item to be returned,
at least one condition of return, or
at least one item identification data; and
transmitting the item data to at least one server, wherein the at least one server comprises at least one of a local server or a remote server.

29. The method according to claim 27, wherein the method comprises at least one of:
storing the item data on at least one server storage component; or
exchanging data between the least one server and the at least one base unit, wherein the at least one base unit comprises at least one base unit storage component and wherein the method comprises exchanging data between the at least one server and the at least one base unit storage component.

30. The method according to claim 26, wherein the method comprises at least one of:
executing machine learning techniques;
predicting item data based on historic data; or
automatically retrieving the historic data from an existing knowledgebase.

31. The method according to claim 26, wherein the method comprises automatically reading the item tag by means of at least one PoS terminal, wherein the at least one PoS terminal comprises at least one reader configured to read the item tag, wherein the at least one reader comprises at least one of:
an RFID reader;
an NFC reader;
an optical scanner;
a pen type reader; or
a laser scanner.

32. The method according to claim 27, wherein the method comprises:
transmitting the item data from at least one reader to the at least one processing component, wherein the at least one reader is configured to use at least one communication protocol comprising at least one of:
Bluetooth,
WLAN,
Zig-bee,
RFID,
NFC, or
Z-wave;
automatically generating at least one reimburse-value via the at least one processing component, wherein the at least one reimburse-value is based on the item data;
retrieving at least one portion of item data from the at least one server via the at least one processing component;
transmitting the at least one reimburse-value to at least one issuing component via the at least one processing component; and
storing the at least one reimburse-value on the at least one server storage component via the at least one processing component.

33. The method according to claim 32, wherein the method comprises:
enabling at least one bank transaction via the at least one issuing component; and
encrypting data by means of an encrypted communication protocol comprise by the at least one issuing component.

34. The method according to claim 26, wherein the at least one payment terminal comprises:
at least one user interface; and
at least one user terminal, wherein the method comprises reading via at least one user terminal at least one of: a credit card, a debit card, an EMV card, an NFC card, an RFID card, an E-wallet, a QR code, a barcode, Google pay, or Apply pay;
wherein the at least one payment terminal is further configured to:
extract one user ID from the at least one user terminal, and
transmit the user ID to the at least one issuing component.

35. The method according to claim 26, wherein the method comprises at least one of:
retrieving information related to a user;
using the information related to the user to transfer an amount of currency from a bank account to a user bank account;
executing at least one online currency transferring;
prompting the user to introduce an NFC bank card into a bank terminal;
initiating a transaction comprising at least one of:
a reversal payment, or
a regular payment; or
retrieving bank card data.

36. The method according to claim 34, wherein the method comprises at least one of:
processing the bank card data, wherein processing the bank card data comprises:
matching the bank card data collected with the user's name and IBAN, and
generating matches between the bank card data collected with the user's name and IBAN;
wherein in case of no matches, the method comprises:
generating a request,
sending the request to the card issuer bank, and
receiving from the card issuer bank data based upon the request, wherein the card issuer data comprises further information for connecting the user's bank card and IBAN.
